(19) United States
(12) Patent Application Publication
(10) Pub. No.: US 2015/0077060 A1
(43) Pub. Date: Mar. 19, 2015

(54) EQUALIZATION DEVICE FOR ASSEMBLED BATTERY

(71) Applicant: DENSO CORPORATION, Kariya-city (JP)

(72) Inventors: Shouichi OKUDA, Nukata-gun (JP); Ryotaro MIURA, Nagoya-city (JP)

(21) Appl. No.: 14/477,921

(22) Filed: Sep. 5, 2014

(30) Foreign Application Priority Data
Sep. 13, 2013 (JP) 2013-190595

(51) Int. Cl. H02J 7/00

(52) U.S. Cl. CPC H02J 7/0019; H02J 7/0072; H02J 7/0052
USPC 320/121

(57) ABSTRACT

In an equalization device for equalizing voltages of battery cells connected in series, each battery cell is provided with an equalization switch and a level shift section. The level shift section includes at least one level shift circuit. Each level shift circuit operates on a power supply voltage supplied from a series circuit of a predetermined number of adjacent battery cells. The level shift circuits are arranged so that potentials of the power supply voltages are different from each other in sequence. In the level shift section, a first level shift circuit outputs a pair of drive voltages by level-shifting a pair of control signals inputted from a second level shift circuit adjacent to the first level shift circuit, and a last level shift circuit outputs the pair of drive voltages as a control voltage for a corresponding equalization switch.

### CROSS REFERENCE TO RELATED APPLICATION

This application is based on Japanese Patent Application No. 2013-190595 filed on Sep. 13, 2013, the contents of which are incorporated herein by reference.

### TECHNICAL FIELD

The present disclosure relates to an equalization device for an assembled battery including multiple battery cells connected in series.

### BACKGROUND

A battery, which is mounted on a motor-operated vehicle such as an electric vehicle (EV) or a hybrid vehicle (HV) to supply electric power to a motor of the vehicle, needs a high voltage of, for example, about 300V. For this reason, the battery is configured as an assembled battery including multiple battery cells, each of which has a cell voltage of a few volts, connected in series. A lithium ion battery cell, which has been widely used in recent years, has a high cell voltage. Therefore, when the assembled battery is constructed with the lithium ion battery cells, the total number of battery cells in the assembled battery can be reduced, so that the size of the assembled battery can be reduced.

However, if each battery cell is not used within a predetermined cell voltage range between its minimum effective voltage and its maximum effective voltage, troubles such as a significant reduction in capacity of the battery cell and abnormal heat generation in the battery cell may occur. Further, if the battery cells have different cell voltages due to variations in their capacity, an error of a voltage of the assembled battery with respect to its target voltage may become large. For this reason, an equalization device for monitoring voltages of battery cells and equalizing the voltages has been demanded. JP-A-2012-23848 corresponding to U.S. 2013/0162213 discloses an equalization device having an equalization switch provided for each battery cell.

The conventional equalization device has a level shift circuit which is provided for each battery cell and operates on a power supply voltage produced by voltages of adjacent multiple battery cells. The level shift circuits are accumulated from a low potential side to a high potential side. In the equalization device, a control signal for each battery cell is inputted with respect to a ground potential or the like and sequentially transmitted to a high potential side by the level shift circuit. A drive voltage outputted by the last level shift circuit is applied between control terminals of the equalization switch.

In this structure, if a power supply voltage of the level shift circuit is lost due to, for example, the fact that a connector connecting the equalization device and the assembled battery is disconnected, an operation of the level shift circuit becomes undefined, i.e., the drive voltage outputted by the level shift circuit becomes undefined. As a result, there is a possibility that the equalization switch is turned ON despite the fact that the control signal for stopping an equalization process is received.

### SUMMARY

In view of the above, it is an object of the present disclosure to provide a an assembled battery equalization device capable of stably keeping an equalization switch OFF even when a power supply potential of a level shift circuit is undefined in a circuit which controls the equalization switch.

An equalization device is used for equalizing cell voltages of n battery cells of an assembled battery, where n is a positive integer. The battery cells are connected in series in such a manner that a first terminal of the k+1th battery cell is connected to a second terminal of the kth battery cell, where k is a positive integer less than n. The equalization device includes equalization switches and level shift sections.

Each equalization switch is provided for a corresponding one of the battery cells and has energization terminals, control terminals, and a threshold voltage. A current path between the energization terminals is interposed between the first terminal and the second terminal of the corresponding battery cell. The current path conducts when a control voltage not less than the threshold voltage is applied between the control terminals.

Each level shift section is provided for a corresponding one of the battery cells and includes at least one level shift circuit. Each level shift circuit operates on a power supply voltage supplied from a series circuit of a predetermined number of adjacent battery cells of the assembled battery through a first voltage line and a second voltage line. A first one of the level shift sections includes multiple level shift circuits connected in a predetermined manner. Each level shift circuit outputs a pair of drive voltages by level-shifting a pair of control signals inputted to it. The level shift circuits are arranged so that potentials of the power supply voltages supplied to them are different from each other in sequence. In the first one of the level shift sections, a first one of the level shift circuits receives the pair of drive voltages outputted from a second one of the level shift circuits adjacent to the first one of the level shift circuits and interprets the received pair of drive voltages as the pair of control signals for itself. In the first one of the level shift sections, a last one of the level shift circuits outputs the pair of drive voltages as the control voltage for a corresponding equalization switch.

The last one of the level shift circuits includes a first conductivity-type first transistor, a first conductivity-type second transistor, a first conductivity-type third transistor, and a drive voltage determining circuit. Sources of the first transistor and the second transistor are connected to the first voltage line. The first voltage line has a potential overlapping a range of the potential of the power supply voltage supplied to a third one of the level shift circuits adjacent to the last one of the level shift circuits. A drain and a source of the third transistor are connected between a gate and the source of the first transistor. A gate of the third transistor is connected to a gate of the second transistor.

The drive voltage determining circuit is connected between the second voltage line and drains of the first transistor and the second transistor and determines the pair of drive voltages according to ON and OFF states of the first transistor and the second transistor. The third one of the level shift circuits outputs the pair of drive voltages to the gates of the first transistor and the second transistor.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic of an equalization system including equalization device according to a first embodiment of the present disclosure;

FIG. 2 is a first partial detailed view of the equalization device;

FIG. 3 is a second partial detailed view of the equalization device;

FIG. 4 is a state transition diagram of the equalization device;

FIG. 5 is a characteristic diagram of a lithium secondary battery cell;

FIG. 6 is a partial detailed view of an equalization device according to a second embodiment of the present disclosure;

FIG. 7 is a partial detailed view of an equalization device according to a third embodiment of the present disclosure;

FIG. 8 is a partial detailed view of an equalization device according to a fourth embodiment of the present disclosure;

FIG. 9 is a partial detailed view of an equalization device according to a fifth embodiment of the present disclosure;

FIG. 10 is a partial detailed view of an equalization device according to a sixth embodiment of the present disclosure;

FIG. 11 is a partial detailed view of an equalization device according to a seventh embodiment of the present disclosure;

FIG. 12 is a partial detailed view of an equalization device according to a eighth embodiment of the present disclosure; and

FIG. 13 is a partial detailed view of an equalization device according to a ninth embodiment of the present disclosure.

### DETAILED DESCRIPTION

Embodiments of the present disclosure are described below with reference to the drawings in which the same or similar number refers to the same or similar part.

### First Embodiment

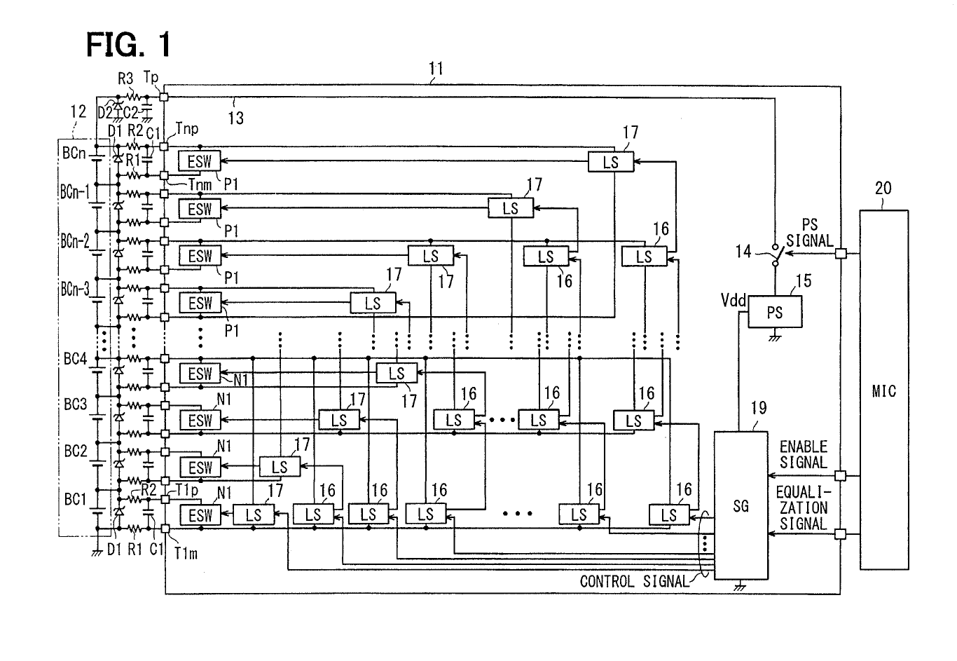

A first embodiment of the present disclosure is described with reference to FIGS. 1 to 5. An integrated circuit (IC) 11 shown in FIGS. 1 to 3 is an equalization device for equalizing voltages of n battery cells BC1 to BCn of an assembled battery 12, where n is a positive integer. The assembled battery 12 is mounted on a motor-operated vehicle, which has a motor and is capable of running by the motor, such as an electric vehicle (EV) or a hybrid vehicle (HV). The assembled battery 12 supplies electric power to the motor.

In the assembled battery 12, the battery cells BC1 to BCn are connected in series in such a manner that a positive terminal (as a second terminal) of the kth battery cell BCk (k=1, . . . , n−1) is connected to a negative terminal (as a first terminal) of the (k+1)th battery cell BCk+1. For example, according to the first embodiment, the assembled battery 12 has eighty lithium secondary battery cells (i.e., n=80) connected in series, and each lithium secondary battery cell has a cell voltage of 3.6V.

A Zener diode D1 is connected between the positive and negative terminals of the battery cell BCi (i=1, n). The negative terminal of the battery cell BCi is connected through a resistor R1 to a terminal Tim of the IC11. The positive terminal of the battery cell BCi is connected through a resistor R2 to a terminal Tip of the IC11. A capacitor C1 is connected between the terminals Tim and Tip. When the voltages are equalized, the resistors R1 and R2 work to limit a discharge current and also work together with the capacitor C1 as a filter circuit.

The negative terminal of the battery cell BC1 is connected to a reference potential. For example according to the first embodiment, the reference potential is a ground potential. A Zener diode D2 is connected between the positive terminal of the battery cell BCn and the ground potential. The positive terminal of the battery cell BCn is connected through a resistor R3 to a power supply terminal Tp of the IC 11. A capacitor C2 is connected between the power supply terminal Tp and the ground potential. The resistor R3 and the capacitor C2 work together as a filter circuit. Inside the IC 11, the power supply terminal Tp is connected to a power supply circuit (denoted as “PS” in FIG. 1) 15 through a power supply line 13 and a switch 14. The power supply circuit 15 produces a power supply voltage Vdd.

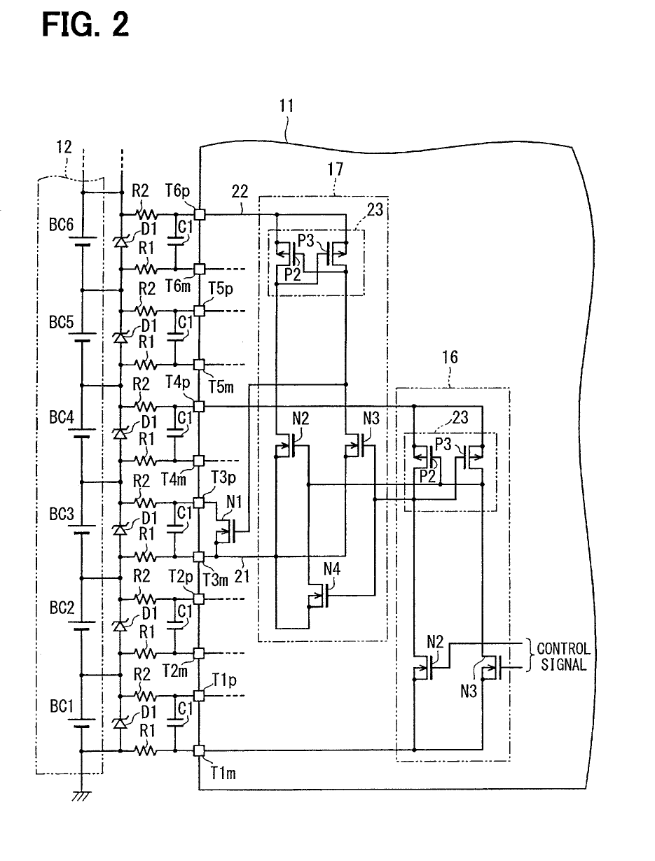

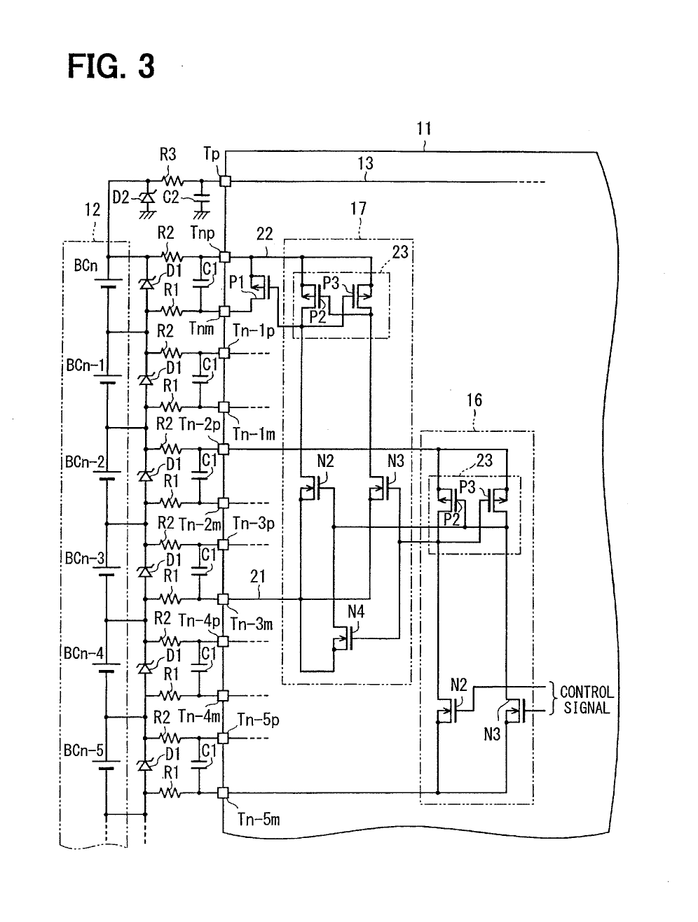

The IC 11 has an equalization switch (denoted as “ESW” in FIG. 1) provided for each of the battery cells BC1 to BCn. The equalization switch provided for each of a half of the battery cells BC1 to BCn is an N-channel MOS transistor, and the equalization switch provided for each of the remaining half of the battery cells BC1 to BCn is a P-channel MOS transistor. Specifically, each of the battery cells BC1 to BCn/2 located on the low potential side is provided with an N-channel MOS transistor N1 as the equalization switch, and each of the battery cells BCn/2+1 to BCn located on the high potential side is provided with a P-channel MOS transistor P1 as the equalization switch. The drain and source of the transistor N1, P1 correspond to energization terminals, and the gate and source of the transistor N1, P1 correspond to control terminals. As shown in FIGS. 2 and 3, a current path between the energization terminals of the transistor N1, P1 is interposed between the positive and negative terminals of the corresponding battery cell. The current path conducts when a control voltage not less than a threshold voltage of the transistor N1, P1 is applied between the control terminals of the transistor N1, P1.

The battery cell BC1 is provided with one level shift circuit (denoted as “LS” in FIG. 1) 17. In contrast, each of the battery cells BC2 to BCn is provided with multiple level shift circuits 16 and 17 which are cascaded to form a level shift section. Each of the level shift circuits 16 and 17 operates on a power supply voltage produced by a series circuit of adjacent four battery cells including the battery cell BCi. The level shift circuits 16 and 17 are cascaded so that potentials of the battery voltages supplied to the level shift circuits 16 and 17 are different from each other in sequence by two of the battery cells. When the total number of the battery cells BC1 to BCn of the assembled battery 12 is odd, a fraction occurs. If the fraction occurs, the level shift circuits 16 and 17 are cascaded so that the potentials of the battery voltages supplied to the level shift circuits 16 and 17 are different from each other by one of the battery cells.

As described above, except when i=1, the battery cell BCi is provided with multiple level shift circuits 16 and 17 which are cascaded. Out of the cascaded level shift circuits 16, 17, the level shift circuit 17 is arranged on the highest potential side and hereinafter sometimes referred to as the “last level shift circuit 17”. The level shift circuit 16 which is arranged on the lowest potential side out of the cascaded level shift circuits 16, 17 is hereinafter sometimes referred to as the “lowest-potential level shift circuit 16”. The level shift circuit 16 which is arranged between the level shift circuit 17 and the lowest-potential level shift circuit 16 is hereinafter sometimes referred to as the “middle level shift circuit 16”.

The lowest-potential level shift circuit 16 outputs a pair of drive signals to an adjacent level shift circuit 16 or 17 on the higher potential side by level-shifting a pair of control signals inputted from the signal generation circuit 19. The level shift circuit 17 generates a pair of drive signals by level-shifting a pair of control signals inputted from an adjacent level shift circuit 16 on the lower potential side and outputs one of the pair of drive signals as a control voltage for the transistor N1, P1.

The middle level shift circuit 16 receives a pair of drive signals from an adjacent level shift circuit 16 on the lower potential side and interprets the received drive signals as a pair of control signals for itself. The middle level shift circuit 16 outputs a pair of drive signals to an adjacent level shift circuit 16 or 17 on the high potential side by level-shifting the pair of control signals. In normal conditions, the pair of control signals is opposite in phase for the operation of the level shift circuit 16, 17. That is, in normal conditions, one of the pair of control signals is at the high level, and the other of the pair of control signals is at the low level. Because of this structure, the pair of control signals outputted from the signal generation circuit 19 is sequentially transmitted from the lowest-potential level shift circuit 16 to the level shift circuit 17 via the middle level shift circuit 16. For the sake of simplicity, in FIG. 1, the pair of control signals is represented by one signal line, and also the pair of drive signals is represented by one signal line.

As shown in FIGS. 2 and 3, the level shift circuit 16, 17 has a so-called cross-latch configuration. For example, as shown in FIG. 3, the last level shift circuit 17 provided for the battery cell BCn to drive the transistor P1 includes N-channel type (i.e., first conductivity type) MOS transistors N2, N3, and N4 (i.e., first, second, and third transistors) and P-channel type (i.e., second conductivity type) MOS transistors P2 and P3 (i.e., fourth and fifth transistors). The last level shift circuit 17 is supplied with a battery voltage from a series circuit of the battery cells BCn-3 to BCn through a first voltage line 21 and a second voltage line 22. A potential of the first voltage line 21 overlaps a range of a potential of a power supply voltage supplied to an adjacent level shift circuit 16, i.e., overlaps a range of a potential of a power supply voltage produced by a series circuit of the battery cells BCn-5 to BCn-2. The source of each of the transistors N2 and N3 is connected to the first voltage line 21. A current path between the drain and source of the transistor N4 is connected between the gate and source of the transistor N2, and the gate of the transistor N4 is connected to the gate of the transistor N3.

The transistor P2 is connected between the second voltage line 22 and the drain of the transistor N2, and the transistor P3 is connected between the second voltage line 22 and the drain of the transistor N3. The transistors P2 and P3 form a driving voltage determining circuit 23 which determines a pair of driving voltages according to ON/OFF states of the transistors N2 and N3. The gate of the transistor P2 is connected to the drain of the transistor P3, and the gate of the transistor P3 is connected to the drain of the transistor P2. As shown in FIG. 3, a drive voltage generated between the second voltage line 22 and the drain of the transistor N2 is applied between the gate and source of the transistor P1. In contrast, as shown in FIG. 2, a drive voltage generated between the first voltage line 21 and the drain of the transistor N3 is applied between the gate and source of the transistor N1.

The level shift circuit 16, which does not directly drive the transistor N1, P1, has a structure formed by removing the transistor N4 from the last level shift circuit 17 which directly drive the transistor N1, P1. The drain of the transistor N2 of the level shift circuit 16 is connected to the gate of the transistor N3 of the adjacent level shift circuit 16 or 17 on the high potential side. The drain of the transistor N3 of the level shift circuit 16 is connected to the gate of the transistor N2 of the adjacent level shift circuit 16 or 17 on the high potential side.

A signal generation circuit 19 (denoted as “SG” in FIG. 1) receives an enable signal and an equalization signal from a microcomputer (denoted as “MIC” in FIG. 1) 20 which is located outside the IC 11. The enable signal indicates whether an equalization process is enabled or disabled. The equalization signal indicates which battery cell BCi is to be discharged and also indicates a discharge time during which the indicated battery cell BCi is to be discharged. During a period of time where the signal generation circuit 19 is supplied with the power supply voltage Vdd from the power supply circuit 15, the signal generation circuit 19 outputs a control signal based on the enable signal and the equalization signal, thereby executing an equalization process to equalize the voltages of the battery cells BC1 to BCn of the assembled battery 12. The IC 11 and the microcomputer 20 form a battery monitor ECU for monitoring the assembled battery 12.

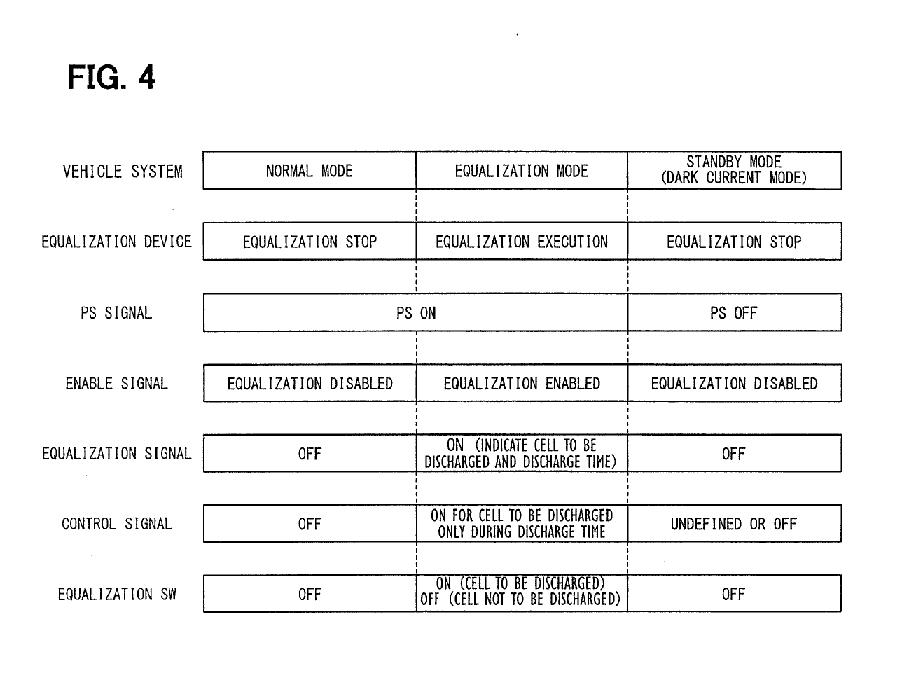

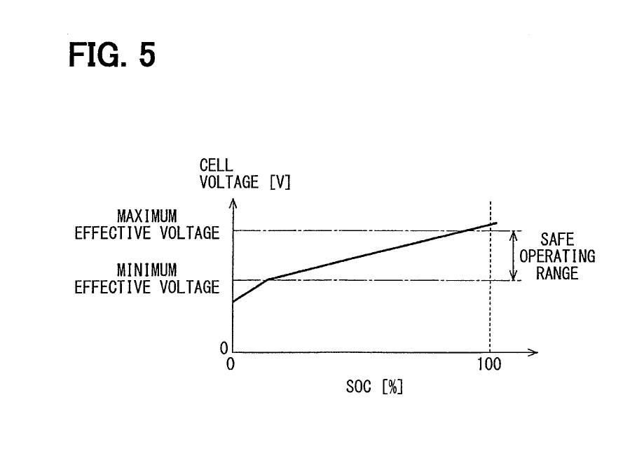

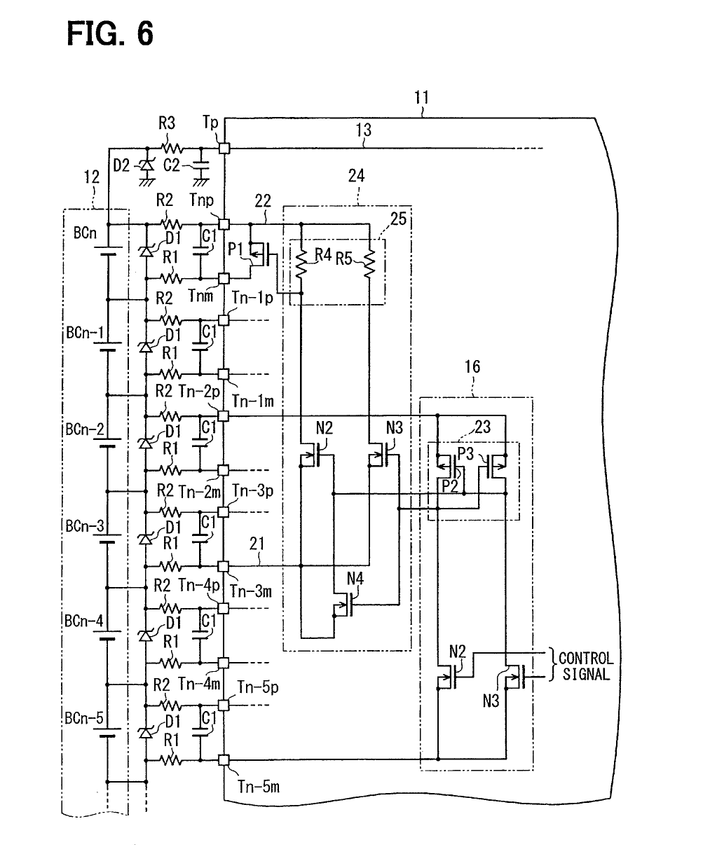

Next, operations of the first embodiment are described below with further reference to FIGS. 5 and 6. The microcomputer 20 executes the equalization process for the assembled battery 12 at the right timing according to a state of a vehicle system. As shown in FIG. 4, when the vehicle system is in a normal mode or in an equalization mode, the microcomputer 20 keeps a power supply (PS) signal at an ON level. The normal mode is a mode where an ignition (IG) switch of the vehicle is ON so that the assembled battery 12 can supply electric power to the motor of the vehicle. The equalization mode is a mode immediately after the IG switch is turned OFF. When the PS signal is at the ON level, the switch 14 of the IC 11 is turned ON so that the power supply voltage Vdd can be generated. Thus, the internal circuitry of the IC 11 becomes operable. When the equalization mode ends, the vehicle system switches to a standby mode (i.e., dark-current mode) to save power consumption of the assembled battery 12. When the vehicle system is in the standby mode, the microcomputer 20 keeps the PS signal at an OFF level.

In the normal mode and the standby mode, the enable signal transmitted from the microcomputer 20 to the IC 11 indicates that the equalization process is disabled. At this time, the equalization signal transmitted from the microcomputer 20 to the IC 11 indicates no battery cell to be discharged as denoted as “OFF” in FIG. 4. Thus, the IC 11 stops the equalization process in the normal mode and the standby mode. That is, in the normal mode and the standby mode, the IC 11 as the equalization device is in an equalization stop state.

In the normal mode, the signal generation circuit 19 outputs the pair of control signals to the lowest-potential level shift circuit 16, 17 provided for each of the battery cells BC1 to BCn so that the gate voltage of the transistor N2 can be at a low level (i.e., 0V) and the gate voltage of the transistor N3 can be at a high level (i.e., Vdd). Thus, the transistors N2 and P3 are turned OFF, and the transistors N3 and P2 are turned ON. As a result, the level shift circuit 16, 17 outputs from the drains of the transistors N2 and N3 a pair of drive voltages, one of which is at a high level (i.e., Vdd), and the other is at a low level (i.e., 0V).

The remaining level shift circuits 16, 17 on the high potential side become the same ON/OFF state as the lowest-potential level shift circuit 16.

As a result, the gate-to-source voltage of the transistor N1, P1, as a control voltage of the equalization switch, becomes less than a threshold voltage Vth of the transistor N1, P1, so that the transistor N1, P1 is turned OFF.

In contrast, for example, when a connector connecting the IC11 and the assembled battery 12 is disconnected at the terminal T1m (refer to FIG. 2) or at the terminal Tn-5m (refer to FIG. 3), the source potential of the transistor N2, N3 of the level shift circuit 16 becomes undefined. In this case, since the transistor N2, N3 cannot be turned ON, and the drain impedance becomes very high.

In an actual circuit, due to influences of noise and leak current of the transistor N2, N3, the drain potential before the connector is disconnected is not kept, and the drain of the transistor N2, N3 changes to the high level. For this reason, a pair of control signals, both of which are at the high level, prohibited in a cross-latch configuration are inputted to the level shift circuit 17 next to the level shift circuit 16 whose power supply potential is undefined.

Assuming that the level shift circuit 17 has the same structure as the level shift circuit 16, all the transistors N2, N3, P2, and P3 are turned ON.

Accordingly, a flow-through current flows, and the control voltage of the transistor N1 or P1 becomes undefined. However, according to the first embodiment, the level shift circuit 17 has the transistor N4. When both the control signals inputted from the level shift circuit 16 become the high level, the transistor N3 is turned ON, and the transistor N4 is turned ON. Thus, the gate and source of the transistor N2 is short-circuited through a low resistance, and the transistor N2 is turned OFF. As a result, the transistor P2 is turned ON, and the transistor P3 is turned OFF. Since the flow-through current is prevented, the transistor N1, P1 can be stably kept OFF so that the IC 11 can stably remain in the equalization stop state.

In contrast, when the PS signal changes to the OFF level in the standby mode, the power supply voltage Vdd of the IC 11 is lost, so that the 1C11 becomes undefined. Even in this case, because of the action of the last level shift circuit 17, the transistor N1, P1 can be stably kept OFF so that the IC 11 can stably remain in the equalization stop state.

When the control signals outputted from the signal generation circuit 19 become undefined, the control signal applied to the transistor N2 needs to be pulled down to the ground potential, and the control signal applied to the transistor N3 needs to be pulled up to the positive terminal of the battery cell BC4. However, if a resistor is used to clamp the potential, a consumption current increases, and also a layout area increases. These disadvantages can be avoided by replacing the lowest-potential level shift circuit 16 with the level shift circuit 17.

Although not shown in the drawings, the IC 11 detects the cell voltages of the battery cells BC1 to BCn and transmits detection values indicative of the detected cell voltages to the microcomputer 20. The microcomputer 20 monitors based on the received detection values whether the cell voltages are equal to each other and fall within a predetermined voltage range (as a safe operating range). The microcomputer 20 identifies at least one battery cell whose cell voltage is higher than those of the other battery cells and needs to be equalized to those of the other battery cells. Further, the microcomputer 20 determines a discharge time during which the identified battery cell needs to be discharged in order to equalize the cell voltage of the identified battery cell to those of the other battery cells. If the microcomputer 20 identifies multiple battery cells whose cell voltages are higher than those of the other battery cells, the microcomputer 20 determines the discharge time for each of the identified battery cells individually.

In the equalization mode, the microcomputer 20 transmits to the IC 11 the enable signal indicating that the equalization process is enabled and the equalization signal indicating the identified battery cell to be discharged and the discharge time during which the identified battery cell is to be discharged. The signal generation circuit 19 executes the equalization process based on the equalization signal. Thus, the IC 11 is in an equalization execution state. Regarding a state of charge (SOC) and a cell voltage, a lithium secondary battery cell has characteristics shown in FIG. 5. In order to safely use the lithium secondary battery cell while increasing its life, it is necessary to control the charge and discharge of the lithium secondary battery cell so that a cell voltage of the lithium secondary battery cell can fall within a safe operating range between its minimum effective voltage and its maximum effective voltage. The microcomputer 20 generates the equalization signal so that the cell voltage of the battery cell BCi can fall within the safe operating range.

The signal generation circuit 19 outputs the pair of control signals to the lowest-potential level shift circuit 16 provided for the battery cell to be discharged so that the gate voltage of the transistor N2 can be at the high level and the gate voltage of the transistor N3 can be at the low level. It is noted that if the battery cell to be discharged is the battery cell BC1, the signal generation circuit 19 outputs such a pair of control signals to the level shift circuit 17. The level shift circuit 16 level-shifts the control signals and outputs a pair of drive voltages having the same logic level to the adjacent level shift circuit 16, 17.

Accordingly, the level shift circuit 17 turns ON the transistor N1, P1. As a result, a discharge current flows out from the battery cell to be discharged through the resistor R2, the transistor N1 or P1, and the resistor R1. Therefore, the SOC, i.e., the capacity of the battery cell to be discharged decreases, and the cell voltage of the battery cell to be discharged decreases. When the individual discharge time elapses, the signal generation circuit 19 changes the pair of controls signals so that the gate voltage of the transistor N2 can be at the low level and the gate voltage of the transistor N3 can be at the high level.

The signal generation circuit 19 outputs the pair of control signals to the lowest-potential level shift circuit 16 provided for the battery cell not to be discharged so that the gate voltage of the transistor N2 can be at the low level and the gate voltage of the transistor N3 can be at the high level. Accordingly, the level shift circuit 17 turns OFF the transistor N1, P1.

As described above, according to the first embodiment, the IC 11 as the equalization device executes the equalization process for the assembled battery 12 by means of a discharging control whenever the IG switch of the vehicle is turned OFF. Thus, it is possible to prevent a significant reduction in capacity of the assembled battery 12, abnormal heat generation in the assembled battery 12, and an error of an output voltage of the assembled battery 12 with respect to its target voltage. Further, when the assembled battery 12 is charged, the IC 11 can execute the equalization process for the assembled battery 12 by means of a charging control by turning ON the equalization switch provided for the battery cell which does not need to be charged.

In the IC 11, the control signals are transmitted to the last level shift circuit 17 while being level-shifted through one or multiple level shift circuits 16 whose power supply potentials are different from each other in sequence, and the last level shift circuit 17 outputs the control voltage to the equalization switch. Out of the level shift circuits 16, 17, at least the level shift circuit 17 includes the transistor N4 in addition to the transistors N2 and N3. Thus, even when the power supply voltage of at least one of the level shift circuits 16 is lost, and the levels of the drive voltages are undefined, the level shift circuit 17 can stably keep the equalization switch OFF.

Since each of the level shift circuits 16 and 17 has a cross-latch configuration, electronic current does not always flow. Therefore, consumption current is small. Further, since such a cross-latch configuration can be formed with CMOS transistors, the circuit size can reduced. In the level shift circuit 17, the transistor N4 prevents the transistors N2 and N3 from being simultaneously turned ON, thereby preventing the flow-through current from occurring.

According to the first embodiment, the level shift circuit 16 has a different structure from the level shift circuit 17. Alternatively, the level shift circuit 16 can have the same structure as the level shift circuit 17. That is, the level shift circuit 16 can have the transistor N4.

Each of the level shift circuits 16 and 17 operates on the power supply voltage produced by a series circuit of a predetermined number (e.g., four) of adjacent battery cells including the corresponding battery cell. However, the number of the battery cells of the series circuit is not limited to four and can be determined by considering a circuit size depending on breakdown voltages of the transistors of the level shift circuits 16 and 17 and a circuit size depending on the number of the cascaded level shift circuits 16 and 17, so that the manufacturing cost can be reduced.

### Second Embodiment

A second embodiment of the present disclosure is described below with reference to FIG. 6. The second embodiment differs from the first embodiment in that the IC 11 includes a level shift circuit 24 instead of the level shift circuit 17. The level shift circuit 24 differs from the level shift circuit 17 in that a driving voltage determining circuit 25 is used instead of the driving voltage determining circuit 23.

As shown in FIG. 6, the driving voltage determining circuit 25 includes resistors R4 and R5. The resistor R4 is connected between the second voltage line 22 and the drain of the transistor N2. The resistor R5 is connected between the second voltage line 22 and the drain of the transistor N3. When the transistor N2 is turned ON, a driving voltage generated across the resistor R4, which is greater than a threshold voltage of the transistor P1, is applied between the gate and source of the transistor P1. The resistors R4 and R5 can prevent the flow-through current from occurring.

### Third Embodiment

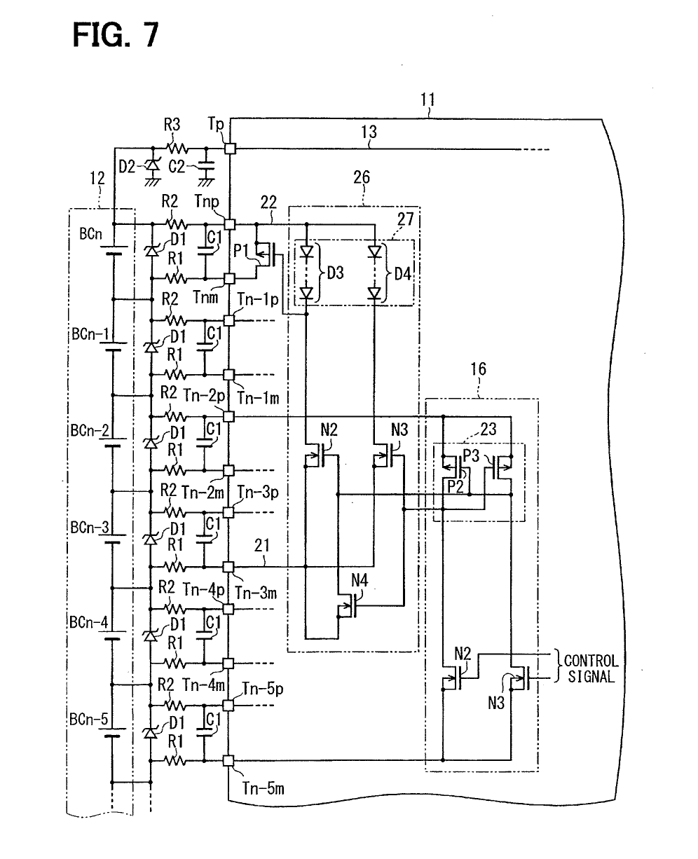

A third embodiment of the present disclosure is described below with reference to FIG. 7. The third embodiment differs from the first embodiment in that the IC 11 includes a level shift circuit 26 instead of the level shift circuit 17. The level shift circuit 26 differs from the level shift circuit 17 in that a driving voltage determining circuit 27 is used instead of the driving voltage determining circuit 23.

As shown in FIG. 7, the driving voltage determining circuit 27 includes at least one diode D3 and at least one diode D4. The diode D3 is connected between the second voltage line 22 and the drain of the transistor N2. The diode D4 is connected between the second voltage line 22 and the drain of the transistor N3. When the transistor N2 is turned ON, a driving voltage equal to a forward voltage of the diode D3, which is greater than a threshold voltage of the transistor P1, is applied between the gate and source of the transistor P1. The diodes D3 and D4 can limit the control voltage applied to the transistor P1 to the forward voltage of the diode D3. In an example shown in FIG. 7, multiple diodes D3 are connected in series to form a diode section between the second voltage line 22 and the drain of the transistor N2, and multiple diodes D4 are connected in series to form a diode section between the second voltage line 22 and the drain of the transistor N3. Alternatively, only one diode D3 can be connected between the second voltage line 22 and the drain of the transistor N2, and only one diode D4 can be connected between the second voltage line 22 and the drain of the transistor N3.

### Fourth Embodiment

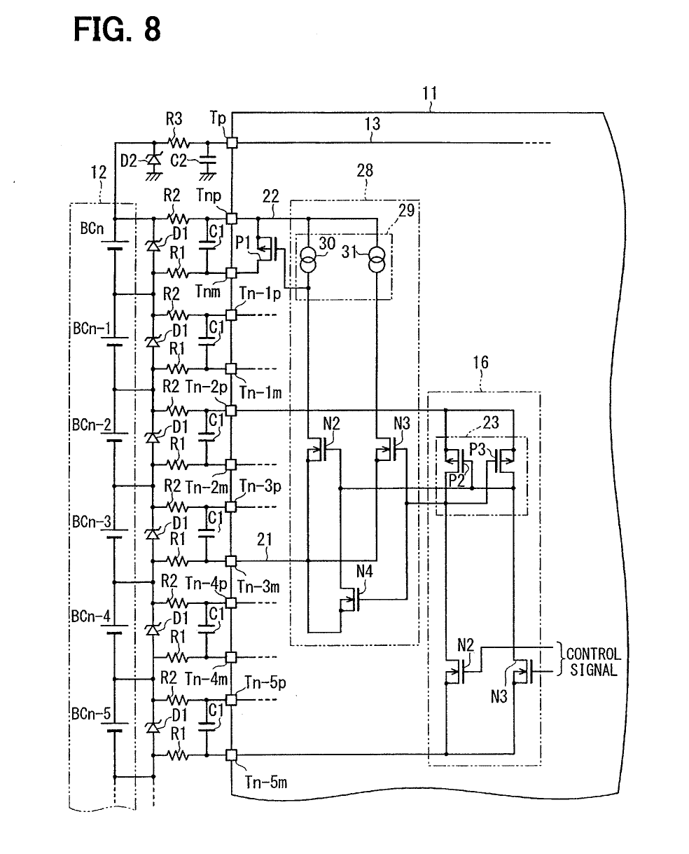

A fourth embodiment of the present disclosure is described below with reference to FIG. 8. The fourth embodiment differs from the first embodiment in that the IC 11 includes a level shift circuit 28 instead of the level shift circuit 17. The level shift circuit 28 differs from the level shift circuit 17 in that a driving voltage determining circuit 29 is used instead of the driving voltage determining circuit 23.

As shown in FIG. 8, the driving voltage determining circuit 25 includes constant current circuits 30 and 31. The constant current circuit 30 is connected between the second voltage line 22 and the drain of the transistor N2. The constant current circuit 30 is connected between the second voltage line 22 and the drain of the transistor N3. When the transistor N2 is turned ON, a driving voltage greater than a threshold voltage of the transistor P1 is applied between the gate and source of the transistor P1. The constant current circuits 30 and 31 can prevent a current exceeding a constant current from flowing in the level shift circuit 28.

### Fifth Embodiment

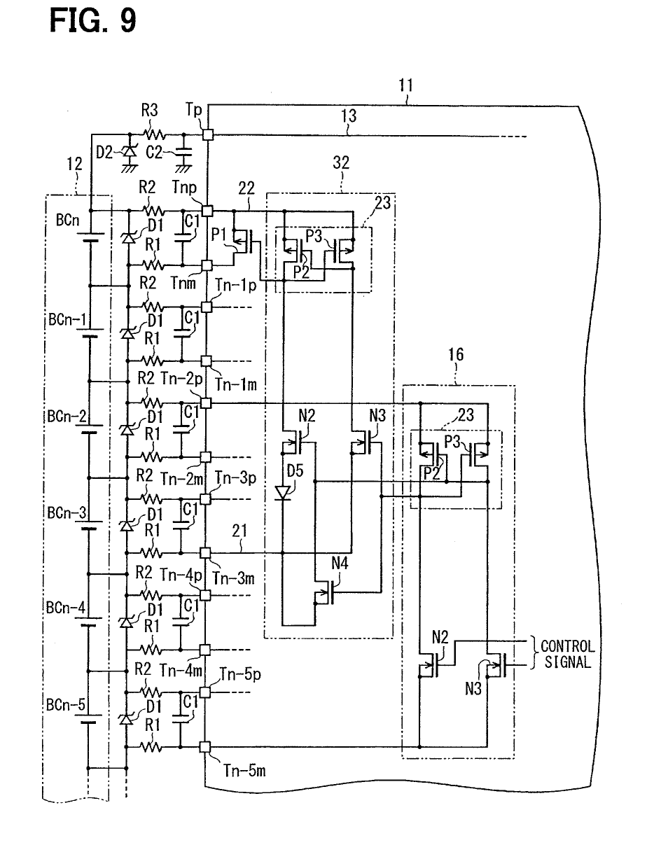

A fifth embodiment of the present disclosure is described below with reference to FIG. 9. The fifth embodiment differs from the first embodiment in that the IC 11 includes a level shift circuit 32 instead of the level shift circuit 17. The level shift circuit 32 differs from the level shift circuit 17 in that a diode D5 is connected between the source of the transistor N2 and the first voltage line 21 in a forward bias manner. In this configuration, the transistor N4 is turned ON when receiving a control signal exceeding its threshold voltage with respect to the first voltage line 21. In contrast, the transistor N2 is turned ON when receiving a control voltage exceeding the sum of its threshold voltage and a forward voltage of the diode D5.

According to the fifth embodiment, when the operation of the level shift circuit 16 is undefined, and the pair of control signals change in directions to turn on the transistors N2 and N3 with the control signals kept at almost the same level, the transistor N4 is turned ON before the transistor N2 is turned ON. That is, even when the transistors N2, N3, and N4 vary in their threshold voltage, it is possible to prevent the following state occurs: the transistors N2 and N3 are ON while the transistor N4 is OFF. Since the transistor N2 is kept OFF to prevent the transistor N1, P1 from being transiently turned ON, no flow-through current occurs. In addition, the same advantages as the first embodiment can be obtained.

### Sixth Embodiment

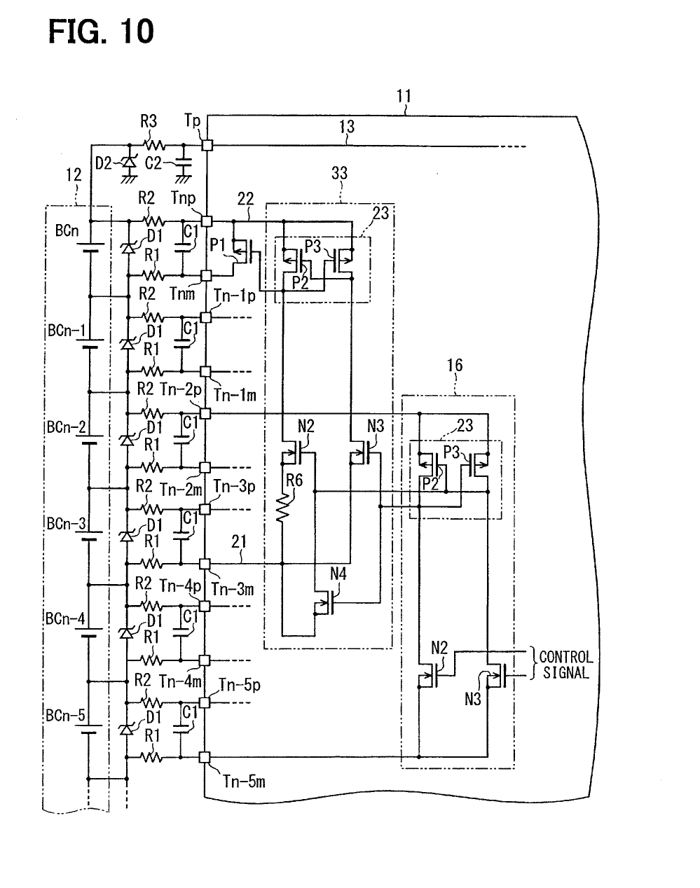

A sixth embodiment of the present disclosure is described below with reference to FIG. 10. The sixth embodiment differs from the first embodiment in that the IC 11 includes a level shift circuit 33 instead of the level shift circuit 17. The level shift circuit 33 differs from the level shift circuit 17 in that a resistor R6 is connected between the source of the transistor N2 and the first voltage line 21. In this configuration, the transistor N4 is turned ON when receiving a control signal exceeding its threshold voltage with respect to the first voltage line 21. In contrast, to keep the transistor N2 ON, the transistor N2 needs to receive a control voltage exceeding the sum of its threshold voltage and a voltage drop across the resistor R6. Thus, the same advantages as the fifth embodiment can be obtained.

### Seventh Embodiment

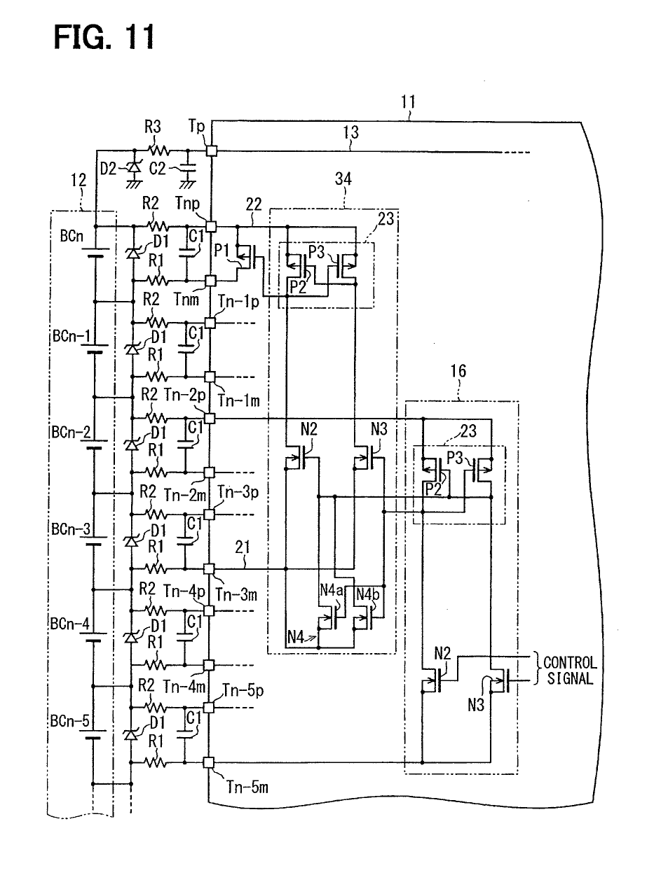

A seventh embodiment of the present disclosure is described below with reference to FIG. 11. The seventh embodiment differs from the first embodiment in that the IC 11 includes a level shift circuit 34 instead of the level shift circuit 17. The level shift circuit 34 differs from the level shift circuit 17 in that the transistor N4 is configured as a parallel circuit of transistors N4a and N4b. The transistors N4a and N4b have the same size (W/L) as the transistors N2 and N3. Therefore, the threshold voltage of the transistor N4 is less than that of each of the transistors N2 and N3. Thus, the same advantages as the fifth embodiment can be obtained.

### Eighth Embodiment

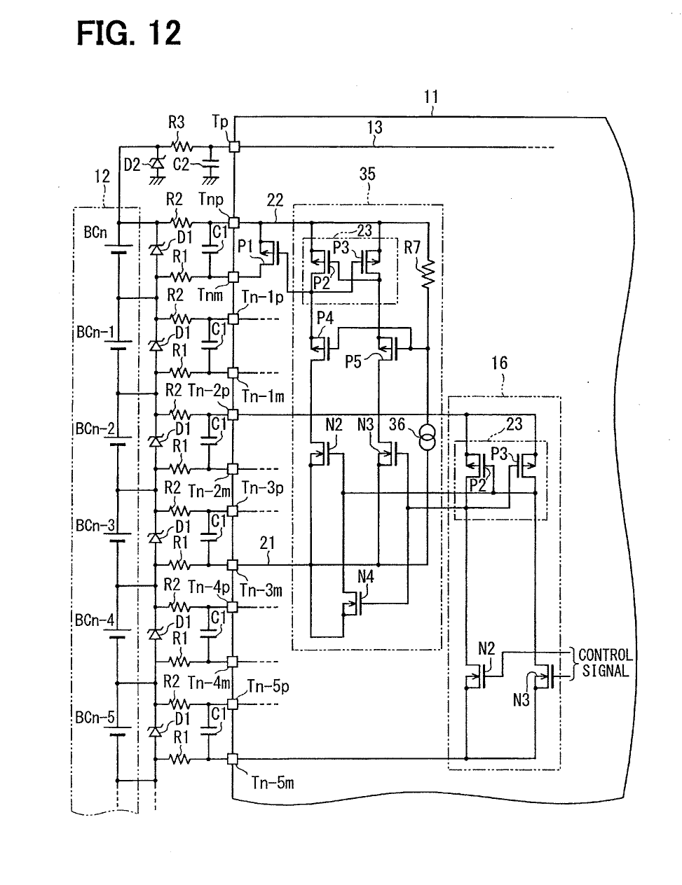

An eighth embodiment of the present disclosure is described below with reference to FIG. 12. The eighth embodiment differs from the first embodiment in that the IC 11 includes a level shift circuit 35 instead of the last level shift circuit 17. The level shift circuit 35 differs from the last level shift circuit 17 in that a P-channel MOS transistor P4 is connected between the driving voltage determining circuit 23 and the drain of the transistor N2 and a P-channel MOS transistor P5 is connected between the driving voltage determining circuit 23 and the drain of the transistor N3. Further, a series circuit of a constant current circuit 36 and a resistor R7 is connected between the first and second voltage lines 21 and 22. A voltage drop across the resistor R7 with respect to the second voltage line 22 is applied to the gates of the transistors P4 and P5.

According to the eighth embodiment, the transistors P4 and P5 of the level shift circuit 35 serve as a limiter circuit to limit a driving voltage applied to the transistor P1. Thus, it is possible to prevent an excessive voltage from being applied between the gate and source of the transistor P1. The same structure as discussed above can be provided to the transistor N1 to protect the transistor N1 from such an excessive voltage.

### Ninth Embodiment

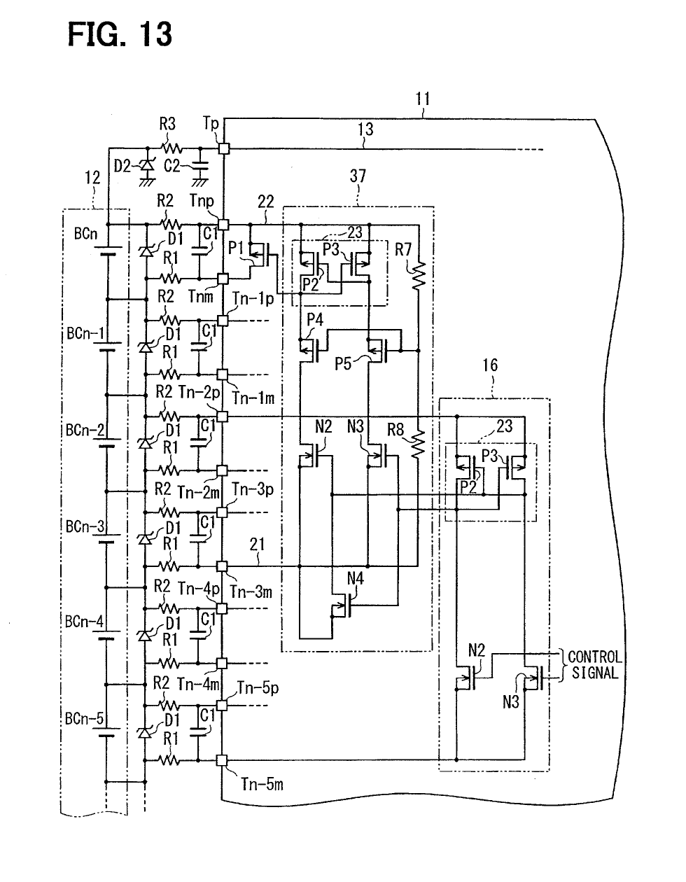

A ninth embodiment of the present disclosure is described below with reference to FIG. 13. The ninth embodiment differs from the eighth embodiment in that the IC 11 includes a level shift circuit 37 instead of the last level shift circuit 35. The level shift circuit 37 differs from the last level shift circuit 35 in that a resistor R8 is used instead of the constant current circuit 36. Thus, the same advantages as the eighth embodiment can be obtained.

### (Modifications)

While the present disclosure has been described with reference to embodiments thereof, it is to be understood that the disclosure is not limited to the embodiments. The present disclosure is intended to cover various modifications and equivalent arrangements within the spirit and scope of the present disclosure.

The equalization switches provided for the battery cells (e.g., the battery cells BC4 to BCn-3) arranged in the middle of the assembled battery 12 can be either N-channel MOS transistors N1 or P-channel MOS transistors P1. The equalization switch can be a bipolar transistor instead of a MOS transistor.

In the embodiments, a reference potential to which the negative terminal of the battery cell BC1 is connected is the ground potential. Alternatively, the reference potential can be other than ground potential.

The power supply voltage on which the level shift circuit provided for the battery cell operates can be produced by a series circuit of adjacent two, three, or five battery cells including the corresponding battery cell. In this case, the level shift circuits are cascaded so that potentials of the power battery voltages supplied to the level shift circuits can be different from each other in sequence by a predetermined number of the battery cells.

In the second to ninth embodiments, like in the first embodiment, at least the lowest-potential level shift circuit 16 can be replaced with the level shift circuit 24, 26, 28, 32, 33, 34, 35, or 37. Also, every level shift circuit 16 can be replaced with the level shift circuit 24, 26, 28, 32, 33, 34, 35, or 37.

In the fifth embodiment, two or more diodes can be connected in series between the source of the transistor N2 and the first voltage line 21 in a forward bias manner. In this case, diodes the number of which is less than the number of the diodes connected between the source of the transistor N2 and the first voltage line 21 can be connected between the source of the transistor N3 and the first voltage line 21 in a forward bias manner.

A time at which the vehicle system enters the equalization mode, a time at which the discharge starts in the equalization process, and a time at which the discharge ends in the equalization process are not limited to those shown in FIG. 4.

The signal generation circuit 19 can restrict the equalization execution state so that the cell voltage of the battery cell indicated by the equalization signal can be kept not less than the minimum effective voltage. For example, the signal generation circuit 19 can restrict the equalization execution state by stopping discharging the battery cell indicated by the equalization signal or reducing the discharging time indicated by the equalization signal.

Such changes and modifications are to be understood as being within the scope of the present invention as defined by the appended claims.

What is claimed is:

1. An equalization device for equalizing cell voltages of a plurality of battery cells of an assembled battery, the number of the plurality of battery cells being n which is a positive integer, the plurality of battery cells being connected in series in such a manner that a first terminal of the k+1th battery cell is connected to a second terminal of the kth battery cell, where k is a positive integer less than n, the equalization device comprising:
a plurality of equalization switches, each equalization switch being provided for a corresponding one of the plurality of battery cells, each equalization switch having energization terminals, control terminals, and a threshold voltage, a current path between the energization terminals being interposed between the first terminal and the second terminal of the corresponding battery cell, the current path conducting when a control voltage not less than the threshold voltage is applied between the control terminals; and
a plurality of level shift sections, each level shift section being provided for a corresponding one of the plurality of battery cells, wherein
each of the plurality of level shift sections includes at least one level shift circuit,
each level shift circuit operates on a power supply voltage supplied from a series circuit of a predetermined number of adjacent battery cells of the assembled battery through a first voltage line and a second voltage line,
a first one of the plurality of level shift sections includes a plurality of level shift circuits connected in a predetermined manner, each level shift circuit outputting a pair of drive voltages by level-shifting a pair of control signals inputted thereto,
the plurality of level shift circuits is arranged so that potentials of the power supply voltages supplied thereto are different from each other in sequence,
in the first one of the plurality of level shift sections, a first one of the plurality of level shift circuits receives the pair of drive voltages outputted from a second one of the plurality of level shift circuits adjacent to the first one of the plurality of level shift circuits and interprets the received pair of drive voltages as the pair of control signals for itself,
in the first one of the plurality of level shift sections, a last one of the plurality of level shift circuits outputs the pair of drive voltages as the control voltage for a corresponding equalization switch,
the last one of the plurality of level shift circuits includes a first conductivity-type first transistor, a first conductivity-type second transistor, a first conductivity-type third transistor, and a drive voltage determining circuit,
sources of the first transistor and the second transistor are connected to the first voltage line,
the first voltage line has a potential overlapping a range of the potential of the power supply voltage supplied to a third one of the plurality of level shift circuits adjacent to the last one of the plurality of level shift circuits,
a drain and a source of the third transistor is connected between a gate and the source of the first transistor,
a gate of the third transistor is connected to a gate of the second transistor,
the drive voltage determining circuit is connected between the second voltage line and drains of the first transistor and the second transistor and determines the pair of drive voltages according to ON and OFF states of the first transistor and the second transistor, and
the third one of the plurality of level shift circuit outputs the pair of drive voltages to the gates of the first transistor and the second transistor.

2. The equalization device according to claim 1, wherein
the drive voltage determining circuit includes a second conductivity-type fourth transistor and a second conductivity-type fifth transistor,
the fourth transistor is connected between the second voltage line and the drain of the first transistor,
the fifth transistor is connected between the second voltage line and the drain of the second transistor,
a gate of the fourth transistor is connected to a drain of the fifth transistor,
a gate of the fifth transistor is connected to a drain of the fourth transistor, and
a voltage generated between one of the first voltage line and the second voltage line and one of the drains of the first transistor and the second transistor is the control voltage for the corresponding equalization switch.

3. The equalization device according to claim 1, wherein
the drive voltage determining circuit includes a first resistor and a second resistor,
the first resistor is connected between the second voltage line and the drain of the first transistor,
the second resistor is connected between the second voltage line and the drain of the second transistor, and
a voltage generated between one of the first voltage line and the second voltage line and one of the drains of the first transistor and the second transistor is the control voltage for the corresponding equalization switch.

4. The equalization device according to claim 1, wherein
the drive voltage determining circuit includes a first diode section and a second diode section,
each of the first diode section and the second diode section includes one diode or a plurality of diodes connected in series,
the first diode section is connected between the second voltage line and the drain of the first transistor,
the second diode section is connected between the second voltage line and the drain of the second transistor, and
a voltage generated between one of the first voltage line and the second voltage line and one of the drains of the first transistor and the second transistor is the control voltage for the corresponding equalization switch.

5. The equalization device according to claim 1, wherein
the drive voltage determining circuit includes a first constant current circuit and a second constant current circuit,
the first constant current circuit is connected between the second voltage line and the drain of the first transistor,
the second constant current circuit is connected between the second voltage line and the drain of the second transistor, and
a voltage generated between one of the first voltage line and the second voltage line and one of the drains of the first transistor and the second transistor is the control voltage for the corresponding equalization switch.

6. The equalization device according to claim 1, wherein
when the pair of control signals outputted from the third one of the plurality of level shift circuit to the last one of the plurality of level shift circuits changes in directions to turn ON both the first transistor and the second transistor, the third transistor is tuned ON before the first transistor is turned ON.

7. The equalization device according to claim 6, further comprising:
a diode connected in a forward direction between the source of the first transistor and the first voltage line.

8. The equalization device according to claim 6, further comprising:
a resistor connected between the source of the first transistor and the first voltage line.

9. The equalization device according to claim 6, wherein
a threshold voltage of the third transistor is less than a threshold voltage of the first transistor.

10. The equalization device according to claim 1, wherein
the last one of the plurality of level shift circuits includes a limiter circuit,
the limiter circuit is connected between the drive voltage determining circuit and the drains of the first transistor and the second transistor, and
the limiter circuit limits the pair of drive voltages as the control voltage for the corresponding equalization switch.
